(19) United States
(12) Patent Application Publication
(10) Pub. No.: US 2010/0330403 A1
(43) Pub. Date: Dec. 30, 2010

(54) Coupling waste heat into batteries

(76) Inventor: Randy Allen Normann, Edgewood, NM (US)

Correspondence Address: RANDY A NORMANN, PO BOX 2910, EDGEWOOD, NM, 87015, US

(21) Appl. No.: 12/802,598

(22) Filed: Jun. 10, 2010

Related U.S. Application Data
(60) Provisional application No. 61/269,799, filed on Jun. 29, 2009.

(51) Int. Cl. H01M 10/50; H01M 10/12

(52) U.S. Cl. 429/62; 29/623.1

(57) ABSTRACT

A system for maintaining battery temperatures for energy storage systems using heat created by power electronic device needed to interface the batteries to external power sources or loads is described. Waste heat is a product of internal resistance found in all electronic devices passing current. High-temperature electronics comprised of, silicon-on-insulator, silicon-on-sapphire, silicon-carbide, gallium-nitride or in conjunction with or combination of other wide bandgap semiconductors can used to monitor, charge or discharge the battery array. A thermal system where heat generated by power electronics is used to assist the thermal management of battery energy storage system increases overall system efficiency.

### PRIORITY

The present application claims priority from the commonly owned and assigned applications No. 61/269,799 Attorney Docket no. RAN004, entitled Maintaining Battery Temperature with Waste Heat Created by Power Electronics, which are incorporated herein by reference.

### RELATED APPLICATIONS

Temperature Management of Batteries such as sodium-sulfur (NaS) batteries for energy storage systems.

### TECHNICAL FIELD

The present invention relates to electrical power storage, and more specifically to electric power storage using sodium-sulfur batteries.

### BACKGROUND

A common method for creating a battery based energy storage system combines a battery with an electronic interface to an external electrical grid. The battery is composed of an array of battery cells to create a nominal voltage and current rating, see FIG. 1. The battery is in the form of DC (direct current). The battery is then interfaced to an ac (alternating current) electrical grid for energy storage and energy recovery by a power electronic interface. The power electronic interface is composed of power electronics and control electronics often referred to as an inverter/converter needed for the charge and discharge of the battery. A battery based energy storage system is comprised of a battery and the power electronic interface as two separate functions in two separate enclosures sharing an electrical connection, see FIG. 2.

A second battery based energy storage system is the energy storage system used for electric cars, electric trucks and trains. These battery systems could also use high-temperature battery technologies as NaS and Zebra cells. Here the battery system has electronics needed to maintain the battery charge and discharge. However, these systems also have a variable speed motor drive circuit. Variable speed motor drives are used to create voltage and current waveforms needed to power the electric motors used to drive the wheels on the electric vehicle.

A sodium-sulfur battery cell is a type of battery cell constructed from molten sodium (Na) and sulfur (S). This type of battery cell has a high energy density, high efficiency of charge/discharge (89-92%) and long cycle life, and is fabricated from inexpensive materials. As such, NaS battery based energy storage systems offer many advantages over other types of energy storage systems. However, the required operating temperature of 125 to 350° C. for such NaS batteries can be difficult to make practical in many applications.

The cell is usually made in a tall cylindrical configuration. The entire cell is enclosed by a steel casing that is protected, usually by chromium and molybdenum, from corrosion on the inside. This outside container serves as the positive electrode, while the liquid sodium serves as the negative electrode. The container is sealed at the top with an airtight alumina lid. An essential part of the cell is the presence of a BASE (beta-alumina sodium ion exchange) membrane, which selectively conducts Na+. The cell becomes more economical with increasing size. In commercial applications the cells are arranged in blocks for better conservation of heat and are encased in a vacuum-insulated box.

During the discharge phase, molten elemental sodium at the core serves as the anode, meaning that the Na donates electrons to the external circuit. The sodium is separated by a beta-alumina solid electrolyte (BASE) cylinder from the container of sulfur, which is fabricated from an inert metal serving as the cathode. The sulfur is absorbed in a carbon sponge. BASE is a good conductor of sodium ions, but a poor conductor of electrons, so avoids self-discharge. When sodium gives off an electron, the Na+ ion migrates to the sulfur container. The electron drives an electric current through the molten sodium to the contact, through the electrical load and back to the sulfur container. Here, another electron reacts with sulfur to form Sn2−, sodium polysulfide. The discharge process can be represented as follows:

2Na+4S→Na2S4 Ecell ˜2 V

As the cell discharges, the sodium level drops. During the charging phase the reverse process takes place. Once running, the heat produced by charging and discharging cycles is sufficient to maintain operating temperatures and usually no external source is required.

Sodium-sulfur batteries have been proposed for use in for flattening the load of an electric power line and shifting the peak of the electric power line, for example as in U.S. Pat. No. 6,522,103. In that patent, in a sodium-sulfur battery system comprising a battery module having a sodium-sulfur battery contained in a thermal insulation container, an amount of peak-shift of an electric power line, which can be performed by the battery module, is calculated using a daily load characteristic of the electric power line and a discharge characteristic of the battery module, and an allowable amount of heat generation in battery and an allowable amount of discharge, and discharge of the battery module is controlled using the calculated result. The batteries were contained in thermal insulation containers to facilitate maintenance of the required high operating temperatures.

The challenges pose by the high required operating temperatures are evident from U.S. Pat. No. 6,958,197. In that patent, a special control system was used to minimize the time lag between charge and discharge cycles so that self-heating of the battery was maintained, and power consumption of separate battery heaters could be reduced.

Sodium sulfur batteries have been proposed as especially suitable for energy storage in electric power applications, where variation in demand for energy can require generation and transmission capability to meet peak demands, while the average demand is much less. The need for effective storage can be even great in connection with energy sources such as wind and solar, where the power output from the generator can also vary. A significant challenge to the use of sodium sulfur batteries for such energy storage applications is the efficient provision and management of the heat required to maintain the battery's required operating temperature.

Sodium sulfur batteries require power electronic circuits to control charging and interface the battery energy to external loads or power grid. In existing sodium sulfur energy storage systems, the electronic control and interface circuits are housed in a separate enclosure, away from the hot batteries.

For purposes of illustration, the sodium sulfur battery has been used. However, all battery chemistries have a preferred operating temperature range where the battery's performance and operating life can be maximized. As such, all battery based energy storage systems need thermal temperature management.

All electronic devices create waste heat as a function of internal resistance and current. This is especially true of power electronic devices which handle high voltages and currents. This is evidence enough by the large finned heat sinks found mounted on power amplifiers used in audio equipment.

The operating life of normal power electronics is a function of leakage current and metallization of the silicon electronic devices. Leakage currents cause excessive heat in high voltage operations. High current densities cause metal migration weakening the conductivity of the circuit and increasing resistance and generation of waste heat.

High-temperature electronics components are electronic devices produced with SOI (Silicon-On-Insulator), SOS (Silicon-On-Sapphire), SiC (Silicon-Carbide), GaN (Gallium-Nitride) or other wide bandgap materials. SOI and SOS reduce the leakage current produced when silicon electronic devices are exposed to elevated temperatures by building the circuit transistors on a nonconductive base material as silicon-oxide, intrinsic silicon or sapphire among others. Leakage current is reduced by a factor of 100. Metallization of these devices uses large conductive pads built with high density metals to greatly reduce current density and loss of electrical connection through metal migration.

High-temperature electronics use advanced circuit interconnections based on ceramic substrates or ceramic circuit boards not found in conventional power electronic circuits. Ceramic circuit boards include SiC ceramic with a very high thermal conductivity. This invention is enabled, in part, by developments in high-temperature circuit board designs developed for geothermal well monitoring systems by the inventor and others.

High-temperature electronics developed for geothermal well monitoring encompass complete solutions for all electronic components and hardware as geothermal wells produce fluids at temperatures of 100 to 350° C. without any place for self generated waste heat from electronic devices to go other than into the hot fluid. As such, the electronics must operate at elevate temperatures at all times and dissipate waste heat in to that heated environment.

### SUMMARY OF THE INVENTION

Our invention adapts the normal heat generation found in electronic power systems for use in maintaining the required elevated temperature of batteries. This reduces or eliminates the need for external heat for maintaining battery temperature.

Our invention is unique as our concept is building the power electronic interface out of advanced Silicon-On-Insulator and Wide bandgap semiconductors along with a complete set of electronic component solutions developed for long-term monitoring of geothermal wells and commercial aircraft engines. These electronic systems can operate for years at temperatures required by sodium-sulfur batteries.

Our invention is unique as we are using two sets of power devices. One set is thermally coupled to the battery and the other is not. Depending on the battery temperature, the selection power devices can either heat or to avoid heating the battery when the power electronics are operating.

Our invention is unique as we are building the power electronic interface using circuit boards built with SiC ceramic. SiC ceramic provides a means to thermally move heat from electronic devices to secondary structures, as the battery.

Our invention is unique because the use of heat generated from a variable speed motor drive circuit can significantly improve the thermal management of sodium-sulfur and Zebra cell technology for use in electric vehicles. Thermal batteries as sodium-sulfur and Zebra cells have two advantages over lithium ion batteries. Thermal batteries use materials which exist in great abundance while lithium has a limited supply. Also, thermal batteries are safer while lithium batteries have an explosive failure component.

### BRIEF DESCRIPTION OF THE DRAWINGS

FIG. 1 is a schematic illustration of an array of battery cells suitable for creation of a desired voltage, current, or voltage/current combination.

FIG. 2 is a schematic illustration of an existing based energy storage system.

FIG. 3 is a schematic illustration of an example embodiment of the present invention, with a battery array heated by the power electronic devices interfaced to a power distribution grid.

FIG. 4 is a schematic illustration showing an improvement over FIG. 3 by adding a second set of electronic power devices which will not heat the batteries if the batteries are already at temperature.

FIG. 5 is an illustration of a battery based energy system mounted on a power line pole.

FIG. 6 is an illustration of a battery based energy system mounted in an electric vehicle where the variable speed motor controls are thermally connected to the battery.

### DESCRIPTION OF THE INVENTION

The present invention provides a means for using the heat created by the power devices in a power electronic interface circuit for the thermal management of the battery in a battery based energy storage system. The present invention is described in the context of sodium-sulfur batteries, but can be applicable to other battery or storage technologies with temperature requirements above the ambient temperature.

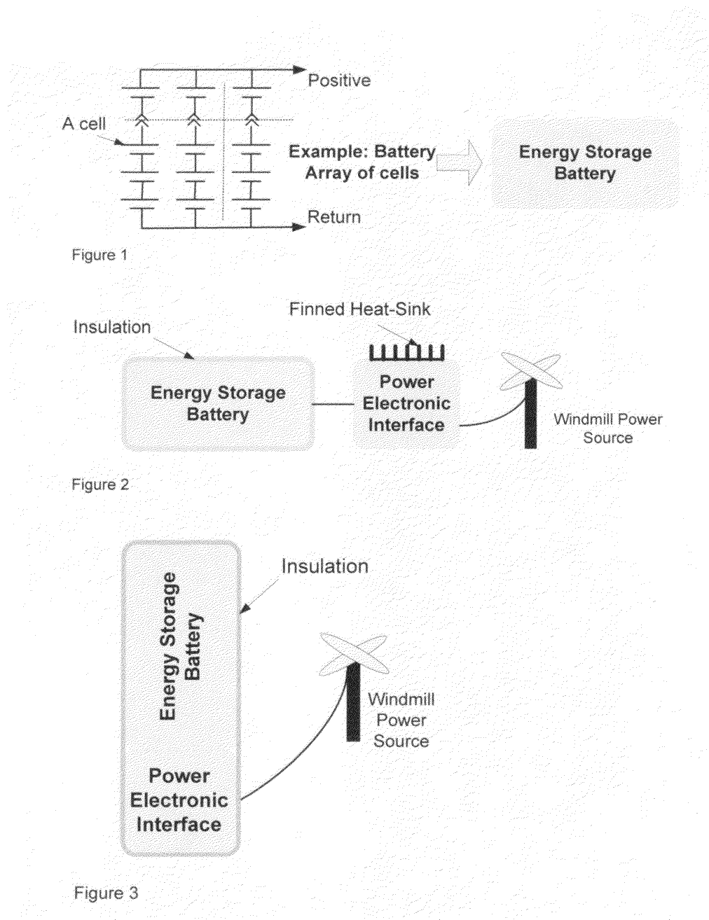

FIG. 1 is a simple illustration that a battery is composed of an array of battery cells. Any voltage or current or combination of voltage and current capability of the battery can be designed by placing battery cells in the array as serial stacks of cell or parallel cells or stacks of cells.

Previous sodium-sulfur batteries rely on self-heating of the battery, which is generally available only during charge or discharge cycles. Further, the charge or discharge rate is often determined by the requirements of the external power system, and often it is not practical to change charge or discharge rates solely for battery temperature control. A separate source of heat is therefore generally employed, often either an electric heater or a solar heater. Electric heating of the battery consumes energy that would otherwise be available to distribute. Solar heating relies on exposure to sunlight which can be inconsistent, and can limit the size of the battery array, and can cause undesirable thermal cycling of the batteries.

Current art of battery based energy storage systems is illustrated in FIG. 2. Here power electronic interface maintained in a separate enclosure. Waste heat generated by the internal resistance found in all electronics power devices is dissipated into air by passive convection or active cooling. The waste heat can be as much as 10% of the total system energy being used for charging and returning the energy from the batteries.

In one example embodiment, a sodium-sulfur battery array such as that illustrated in FIG. 1 is used in connection with high-temperature designed electronics. The heat created in the electronic power interface is thermally connected to the battery inside a single enclosure as shown in FIG. 3. This heat helps maintain the required temperature of the battery. In turn, the batteries require less external heating. In turn, the electronics are exposed to the elevated temperature of the batteries. Here the electronics must operate under continuous elevated temperatures. High-temperature electronic systems developed for aircraft engines and geothermal well monitoring are capable of long operating life times under harsh high temperature conditions.

In addition to conserving energy needed to maintain battery temperature, placing the electronics in the same enclosure as the batteries, reduces the size of the system. The smaller the system is more easily placed in locations not currently available to existing battery based energy storage systems. One such example is placing the battery system on a power-line pole within a neighborhood as illustrated in FIG. 5.

In many cases, the power electronics could be used to maintain other power functions not related to the charge and discharge of the batteries. These other functions could be used in ‘smart grid’ power controlling functions as power controlling of local energy sources as wind and solar. These functions will aid in maintaining battery temperature with waste heat normally last in other power control system electronics.

Sodium-sulfur batteries benefit from being vertical. Vertical sodium-sulfur batteries are easier and less expensive to build. The electrical connection of the batteries can be placed on top. Here the high-temperature electronics could be mounted below the battery array. Simple thermal spreaders as steel plates could provide thermal coupling of heat generated by the electronic devices to the sodium-sulfur cells. FIG. 3 is an illustration of this concept where both the electronics used to control charging and recovery of battery energy are located in the same thermally insulated housing.

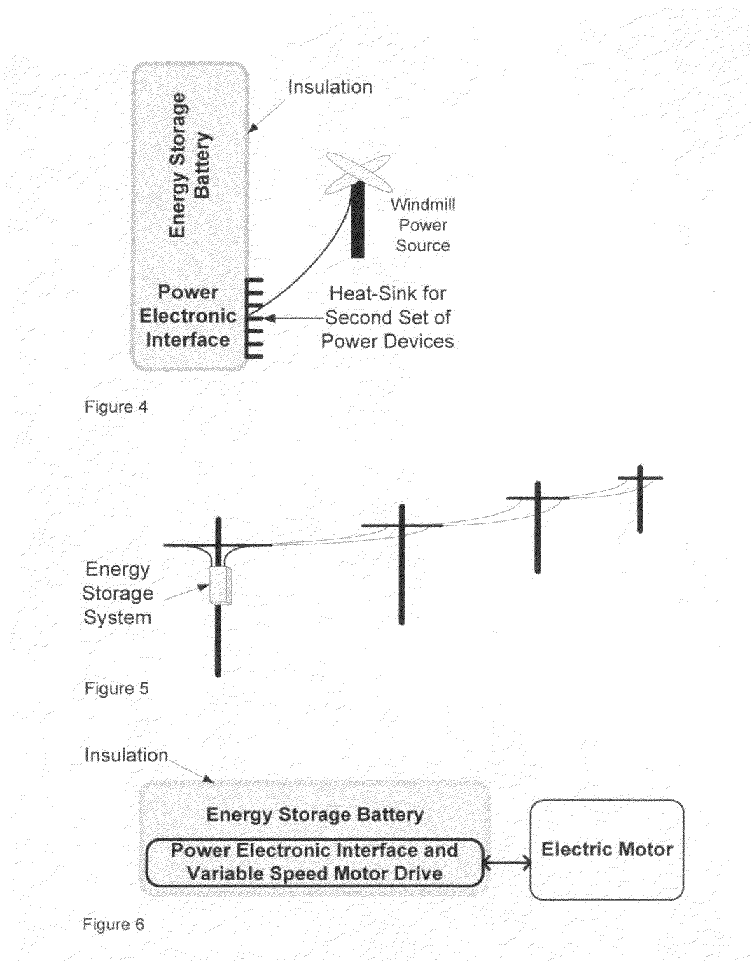

The use of a second set of electronic power devices could be incorporated into the power electronic interface. One set of power devices is thermally coupled to the battery while the other set is coupled to external air cooled heat sink. Now battery temperature monitoring circuits could choose which set of power devices to use based on the temperature needs of the battery. An illustration of this concept is shown in FIG. 4.

Silicon-Carbide, SiC, ceramic is not used in building the circuit boards needed for mounting electronic devices because of its poor dielectric properties. However, SiC ceramic is a very good thermal conductor. In another embodiment of this invention, the use of SiC ceramic circuit boards improves the thermal conductivity between the power electronic interface circuit components and the battery.

An illustration of our invention is shown in FIG. 6. Here the heat generated in power electronics needed for electric vehicles is also used to help maintain the operating temperature of the vehicles' battery energy storage system. This is critical in saving energy otherwise needed for the thermal management of the battery energy storage system. Energy saved allow for greater mileage between charges. Our invention is critical to the adaption of thermal batteries as NaS and Zebra cell technologies for use in electric vehicles.

The particular sizes and equipment discussed above are cited merely to illustrate particular embodiments of the invention. It is contemplated that the use of the invention can involve components having different sizes and characteristics. It is intended that the scope of the invention be defined by the claims appended hereto. The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention.

We claim:

1) A method for the thermal management of an electrical energy storage assisted by the use of heat generated in electronic devices.
A method according to claim 1, wherein the energy storage system is based on a battery technology requiring elevated temperatures to optimize battery performance.
A method according to claim 1, wherein the battery and power electronic interface circuits are mounted in the same enclosure.
A method according to claim 1, wherein the battery is thermally connected to the power electronic interface used to interface the battery energy storage to an external electrical load.
A method according to claim 1, wherein the battery is thermally connected to the electronic power circuits used for controlling the charge and discharge of the battery.
A method according to claim 1, wherein the battery array is thermally connected to electronic devices used for purposes other than interfacing the battery storage system to an external electrical grid.
A method according to claim 1, wherein a battery has maintained elevated temperatures by a power electronic interface composed of high-temperature electronics operating at or above the battery required operating temperature.
A method according to claim 1, wherein the electronic devices in the power electronic interface are high-temperature electronics comprised from any or in part; silicon-on-insulator, silicon-on-sapphire, silicon-carbide, gallium-nitride or in conjunction with or combination of other wide bandgap semiconductors.
A method according to claim 1, wherein the thermal management of the battery is assisted by heat generated in external power electronic device thermally connected to the battery by air or liquid transport.
A method according to claim 1, wherein the power electronic interface has multiple power electronic devices where some devices are thermally connected to the battery while others are not thermally connected to the battery allowing internal logic to either choose to heat the battery or not to heat the battery.
A method according to claim 1, wherein temperature control logic internal to the power electronic interface can either select the power electronic devices thermally connected to heat the battery or power electronic devices thermally connection a conventional air cooled heat sink.
A method of according to claim 1, wherein a plural of circuit functions are performed by electronic systems thermally connected to the battery array for the purpose of maintaining battery operating temperature.
A method according to claim 1, wherein thermal connection between the electronic devices and the battery is composed of electronic devices on mounted thermally conductive silicon-carbide.

2) A method for creating a battery based energy storage system mounted on a power-line pole.
A method according to claim 2, wherein the telephone pole is any pole including telephone poles.

3) A method for the thermal management of an electrical energy storage assisted by heat generated in electric motor drive circuits.
A method according to claim 3, wherein the electric motor drive circuit is a variable speed control circuit for a motor used to drive an electric vehicle.
A method according to claim 3, wherein the energy storage system is based on a battery technology requiring elevated temperatures such as sodium-sulfur or Zebra cells.
A method according to claim 3, wherein the battery and power electronic interface circuits are mounted in the same enclosure.
A method according to claim 3, wherein the thermal management of the battery is assisted by heat generated in external power electronic devices thermally connected to the battery by air or liquid transport.
A method according to claim 3, wherein the variable speed motor drive circuit has multiple power electronic devices where some devices are thermally connected to the battery while others are not thermally connected to the battery allowing internal logic to either choose to heat the battery or not to heat the battery.
